(19) United States
(12) Patent Application Publication
(10) Pub. No.: US 2026/0217911 A1
(43) Pub. Date: Jul. 30, 2026

(54) POLYCARBONATE-BASED VITRIMER MATERIALS AND CORRESPONDING METHODS

(71) Applicants: James Eagan, Akron, OH (US); Junpeng Wang, Peninsula, OH (US); Mark Foster, Stow, OH (US); Satej Joshi, Akron, OH (US); Seiyoung Yoon, Stow, OH (US); Sophia Aracri, Akron, OH (US)

(72) Inventors: James Eagan, Akron, OH (US); Junpeng Wang, Peninsula, OH (US); Mark Foster, Stow, OH (US); Satej Joshi, Akron, OH (US); Seiyoung Yoon, Stow, OH (US); Sophia Aracri, Akron, OH (US)

(21) Appl. No.: 19/147,255

(22) PCT Filed: Jan. 11, 2024
(86) PCT No.: PCT/US2024/011268

§ 371 Date: Jul. 10, 2025

Related U.S. Application Data
(60) Provisional application No. 63/438,338, filed on Jan. 11, 2023.

(51) Int. Cl. C08G 64/42

(52) U.S. Cl. CPC C08G 64/42

(57) ABSTRACT

A method of producing a vitrimer includes reacting an epoxide group containing compound with a carboxylic acid group containing compound, where one or more of the epoxide group containing compound and the carboxylic acid group containing compound is a polycarbonate-based material. The vitrimer includes a β-hydroxy ester group where the epoxide group reacts with the carboxylic acid group. A composition includes a vitrimer which is a reaction product of an epoxide group containing compound and a carboxylic acid group containing compound, where one or more of the epoxide group containing compound and the carboxylic acid group containing compound is a polycarbonate-based material.

### CROSS-REFERENCE TO RELATED APPLICATIONS

This application claims the benefit of U.S. Provisional Application No. 63/438,338, filed on Jan. 11, 2023, which is incorporated herein by reference.

### STATEMENT REGARDING FEDERALLY SPONSORED RESEARCH

This invention was made with government support under DE-EE0009297 awarded by the U.S. Department of Energy. The government has certain rights in the invention.

### FIELD OF THE INVENTION

Embodiments of the present invention relate to polycarbonate-based vitrimer materials, which may be referred to as β-hydroxy ester polycarbonate vitrimers.

### BACKGROUND OF THE INVENTION

Polymer materials are currently utilized in carbon fiber-reinforced polymer (CFRP) composites. These CFRP composites have been widely used in the aircraft and automobile industries. However, the epoxy resins utilized for certain conventional CFRP composites are typically not recyclable, causing concerns about the sustainability of their use.

Lightweight composites, such as CFRP composites, are useful to enable reduced fuel usage, reduced carbon emissions, and increased range in air and ground transportation. The superior weight savings of carbon fiber thermoset composites is impeded by material and production costs, and the limited options available for composite repair and recycle. The sector for recovering and recycling these materials is currently overwhelmed by an abundance of materials and limited market opportunities, rendering landfilling a more attractive alternative in most instances.

There remains a need in the art for improved recyclable materials.

### SUMMARY OF THE INVENTION

A first embodiment of the present invention provides a method of producing a vitrimer including steps of providing an epoxide group containing compound; providing a carboxylic acid group containing compound; wherein one or more of the epoxide group containing compound and the carboxylic acid group containing compound is a polycarbonate-based material; combining the epoxide group containing compound with the carboxylic acid group containing compound to form a reaction mixture; and subjecting the reaction mixture to conditions that will allow the epoxide group containing compound to react with the carboxylic acid group containing compound to thereby form the vitrimer; wherein the vitrimer includes a β-hydroxy ester group where the epoxide group reacts with the carboxylic acid group.

A second embodiment of the present invention provides a composition comprising a vitrimer which is a reaction product of an epoxide group containing compound and a carboxylic acid group containing compound; wherein one or more of the epoxide group containing compound and the carboxylic acid group containing compound is a polycarbonate-based material.

A third embodiment of the present invention provides a method or composition as in any embodiment above, wherein only the epoxide group containing compound is a polycarbonate-based material.

A fourth embodiment of the present invention provides a method or composition as in any of the first or second embodiments above, wherein only the carboxylic acid group containing compound is a polycarbonate-based material.

A fifth embodiment of the present invention provides a method or composition as in any of the first or second embodiments above, wherein both the epoxide group containing compound and the carboxylic acid group containing compound are polycarbonate-based materials.

A sixth embodiment of the present invention provides a method or composition as in any of the embodiments above, wherein the epoxide group containing compound and the carboxylic acid group containing compound are made of feedstocks which are greater than 80% bio-based.

A seventh embodiment of the present invention provides a method or composition as in any of the embodiments above, wherein from about 5 wt. % to 50 wt. % of the vitrimer is derived from CO₂.

An eighth embodiment of the present invention provides a method or composition as in any of the embodiments above, wherein the epoxide group containing compound is a polycarbonate-based material and is one or more of poly(ethylene carbonate) (PEC), poly(propylene carbonate) (PPC), and poly(cyclohexene carbonate) (PCHC).

A ninth embodiment of the present invention provides a method or composition as in any of the embodiments above, wherein the carboxylic acid group containing compound is a polycarbonate-based material, where the carboxylic acid group containing compound is made by reacting a polycarbonate precursor with a cyclic anhydride.

A tenth embodiment of the present invention provides a method or composition as in the ninth embodiment above, wherein the cyclic anhydride includes one or more of succinic anhydride, maleic anhydride, glutaric anhydride, norbornene anhydride, diglycolic anhydride, and phthalic anhydride.

An eleventh embodiment of the present invention provides a method or composition as in any of the embodiments above, wherein the epoxide group containing compound is not a polycarbonate-based material and includes one or more of diglycidyl ether of Bisphenol A (DGEBA), neopentyl glycol diglycidal ether, vinyl cyclohexene dioxide, trimethylolpropane triglycidal ether (TMPTGE), 1,4-cyclohexenedimethanol diglycidal ether (ChDGE), 4,4′methylenebis(n,n-diglycidylaniline) (MBDGA), epoxidized norbornene linseed oil, tris(4-hydroxyphenyl)methane triglycidyl ether, poly[(phenyl glycidyl ether)-co-formaldehyde], poly[(o-cresyl glycidyl ether)-co-formaldehyde], polyethylene glycol (PEG) diglycidyl ether, and N,N-diglycidyl-4-glycidyloxyaniline.

A twelfth embodiment of the present invention provides a method or composition as in any of the embodiments above, wherein the carboxylic acid group containing compound is not a polycarbonate-based material and includes one or more of malic acid, citric acid, succinic acid, maleic acid, diglycolic acid, terephthalic acid, furandicarboxylic acid, acontic acid, benzenehexacarboxylic acid, 2,2′-oxydiacetic acid, trimesic acid, pyromellitic acid, tricarballylic acid, biphenyl-4,4′-dicarboxylic acid, tartaric acid, trimellitic acid, and 1,2,3,4-butanetetracarboxylic acid.

A thirteenth embodiment of the present invention provides a method or composition as in any of the embodiments above, wherein the vitrimer has a glass transition temperature (T_{g}) of from about −20° C. to 120° C.

A fourteenth embodiment of the present invention provides a method or composition as in any of the embodiments above, wherein the vitrimer has a vitrimer transition temperature (T_{V}) of from about 120° C. to 160° C.

A fifteenth embodiment of the present invention provides a method or composition as in any of the embodiments above, wherein the conditions that will allow the epoxide group containing compound to react with the carboxylic acid group containing compound include a temperature of from about 135° C. to 165° C.

A sixteenth embodiment of the present invention provides a method or composition as in any of the embodiments above, wherein the conditions that will allow the epoxide group containing compound to react with the carboxylic acid group containing compound include a temperature of about 150° C.

A seventeenth embodiment of the present invention provides a method or composition as in any of the embodiments above, further including chemically recycling the vitrimer.

An eighteenth embodiment of the present invention provides a method or composition as in any of the embodiments above, further including mechanically recycling the vitrimer.

A nineteenth embodiment of the present invention provides a method or composition as in any of the embodiments above, wherein the vitrimer is defined by the following structure

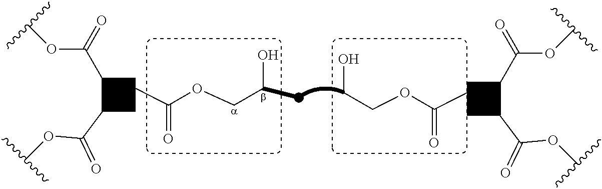

### DETAILED DESCRIPTION OF ILLUSTRATIVE EMBODIMENTS

Advantages of the present invention will become better understood with regard to the following description, appended claims, and accompanying drawings wherein:

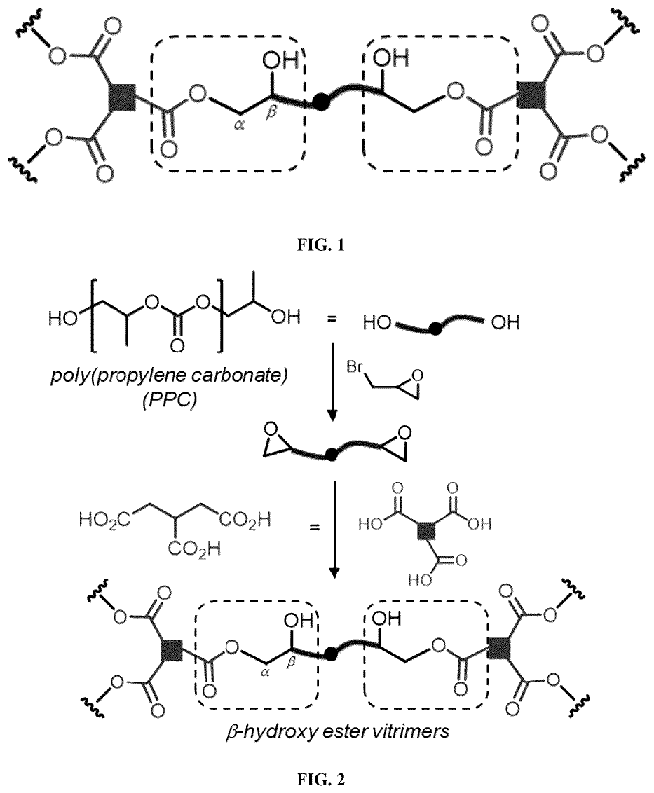

FIG. 1 is a schematic of a β-hydroxy ester polycarbonate vitrimer;

FIG. 2 is a schematic of a reaction scheme;

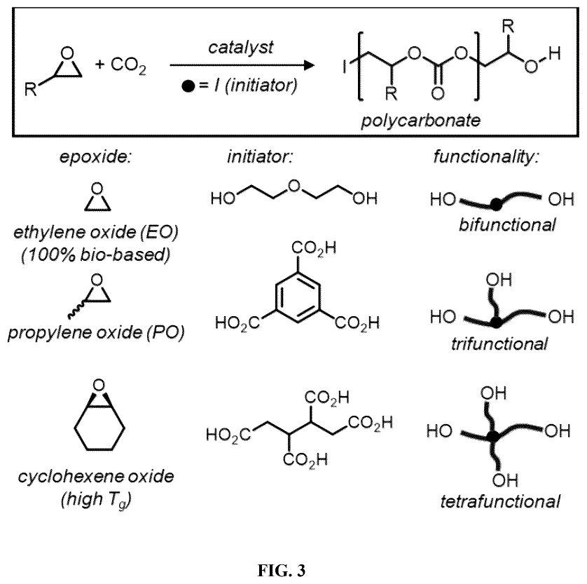

FIG. 3 is a schematic of various suitable compounds for a polycarbonate precursor;

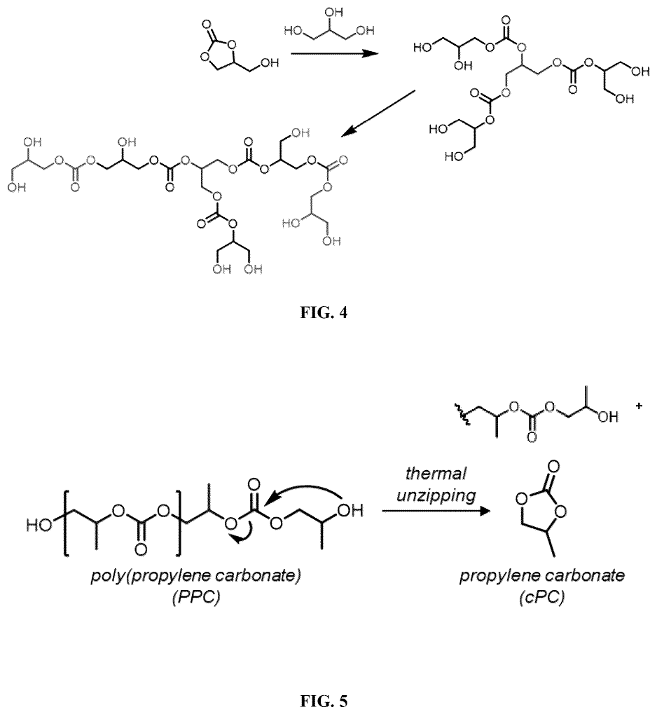

FIG. 4 is a schematic of an alternative reaction scheme;

FIG. 5 is a schematic for recycling material from a vitrimer;

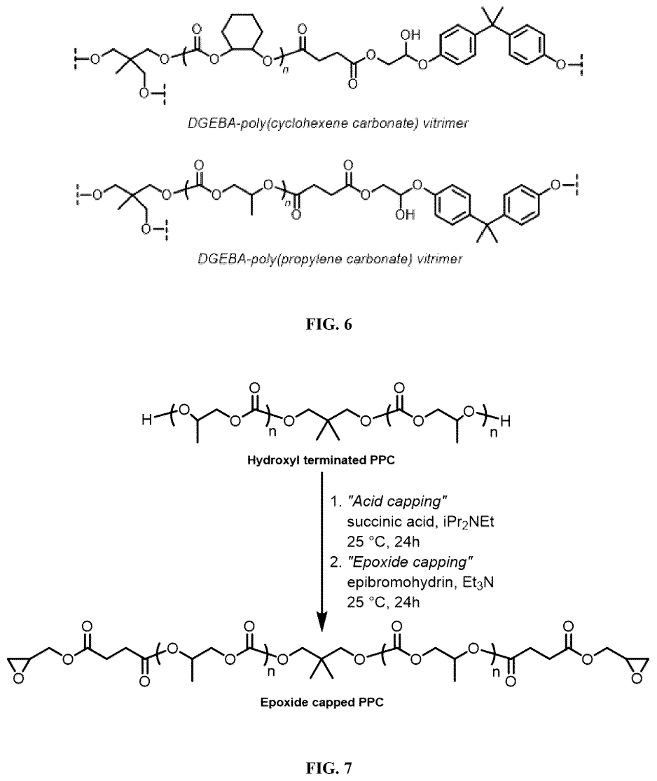

FIG. 6 is a schematic of specific polycarbonate vitrimers;

FIG. 7 is a schematic showing epoxide end capping;

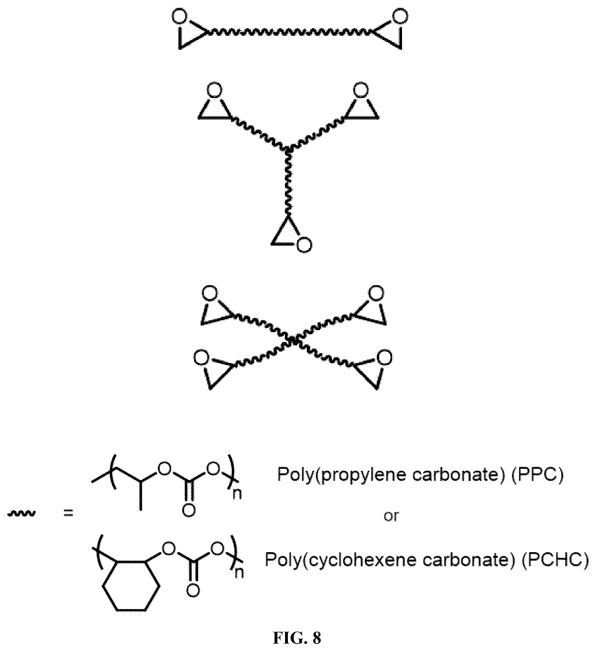

FIG. 8 is a schematic of epoxide capped polycarbonate precursors;

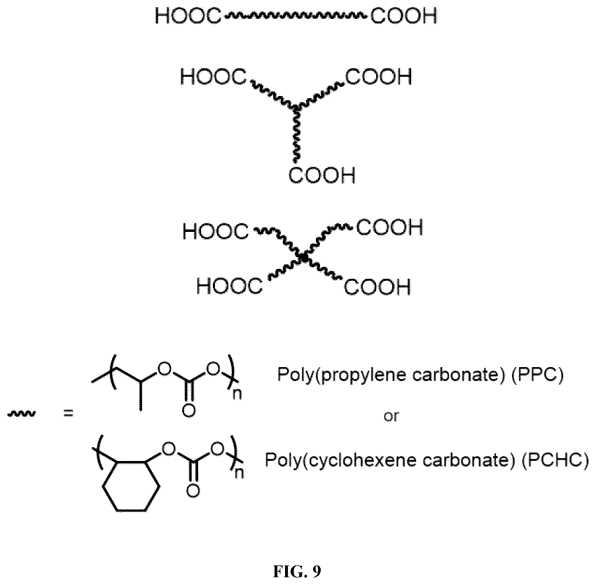

FIG. 9 is a schematic of acid capped polycarbonate precursors;

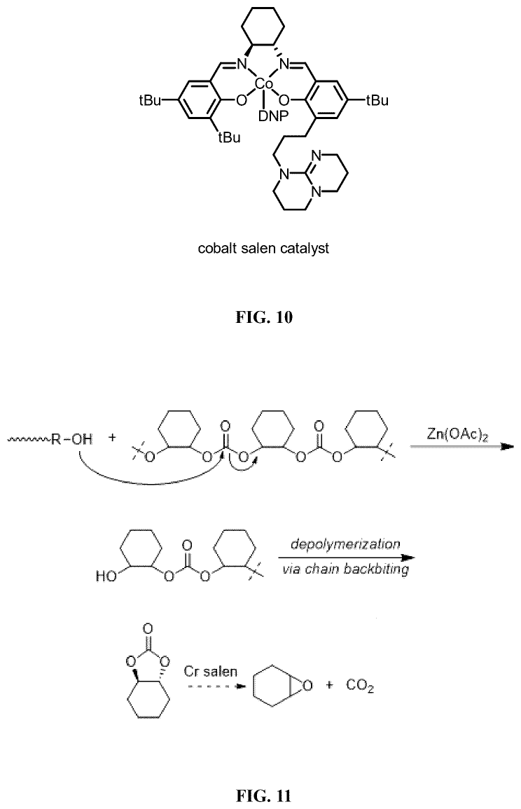

FIG. 10 is a schematic of a cobalt salen catalyst;

FIG. 11 is an alternative schematic for recycling material from a vitrimer;

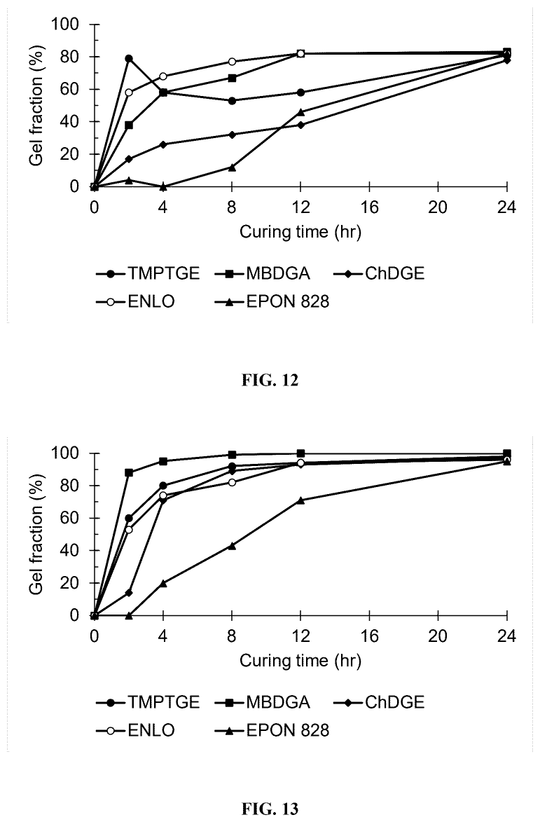

FIG. 12 is a graph showing gel fraction results for various poly(cyclohexene carbonate) (PCHC) vitrimer materials;

FIG. 13 is a graph showing gel fraction results for various poly(propylene carbonate) (PPC) vitrimer materials;

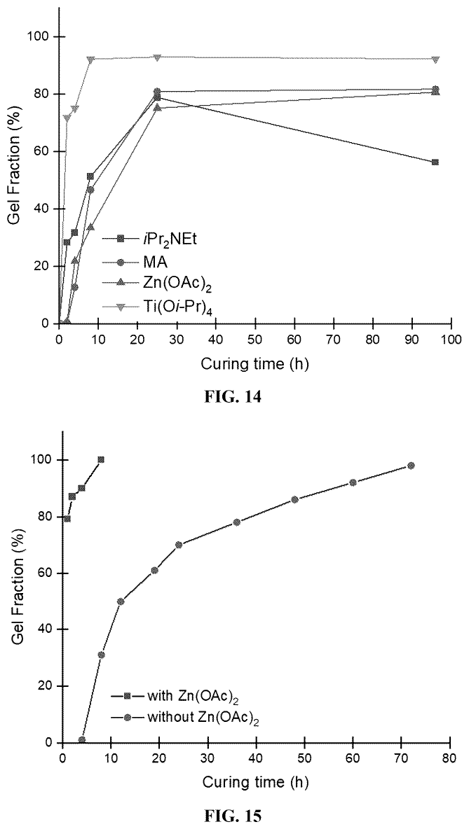

FIG. 14 is a graph showing gel fraction results for PCHC vitrimer network materials prepared with various catalysts/materials;

FIG. 15 is a graph showing gel fraction results for PCHC vitrimer network materials prepared with and without zinc acetate;

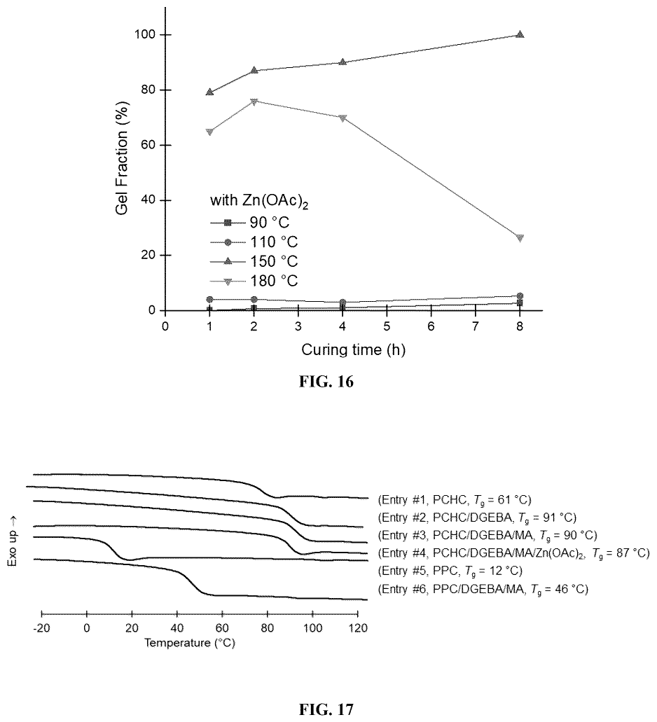

FIG. 16 is a graph showing gel fraction results for PCHC vitrimer network materials prepared with zinc acetate and at various temperatures;

FIG. 17 is a graph showing heat flow results for various vitrimer network materials;

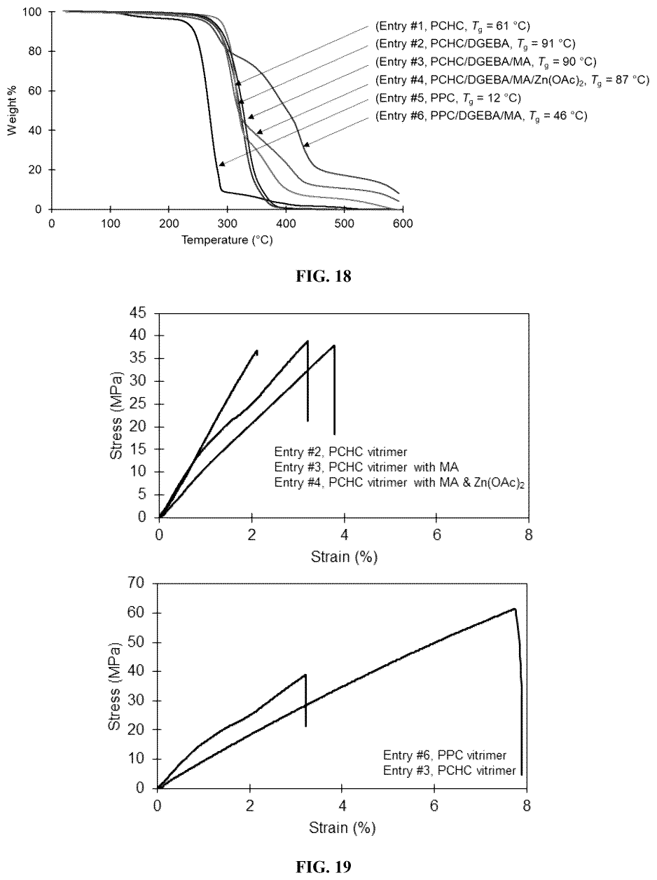

FIG. 18 is a graph showing thermogravimetric analysis results for various vitrimer network materials;

FIG. 19 is graphs showing stress-strain results for various vitrimer network materials;

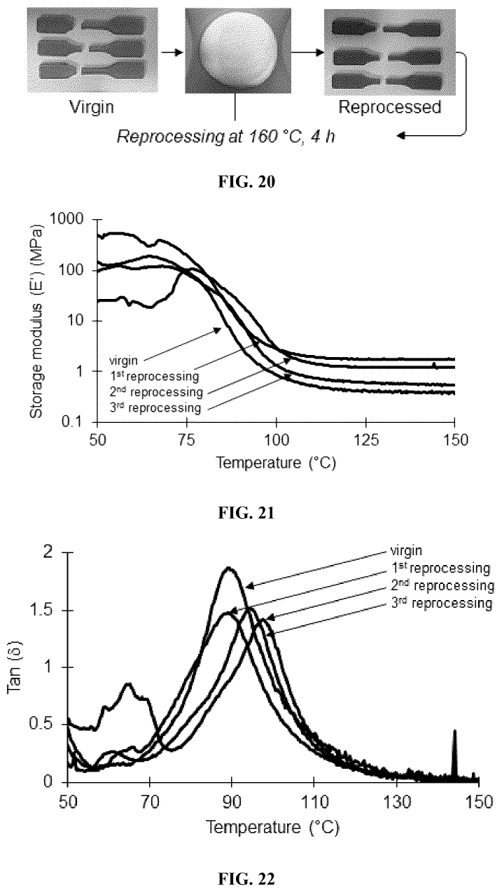

FIG. 20 is a schematic showing a recycling/reprocessing method;

FIG. 21 is a graph showing storage modulus results for a PCHC vitrimer network material at various stages of recycle/reprocessing;

FIG. 22 is a graph showing tan delta results for a PCHC vitrimer network material at various stages of recycle/reprocessing;

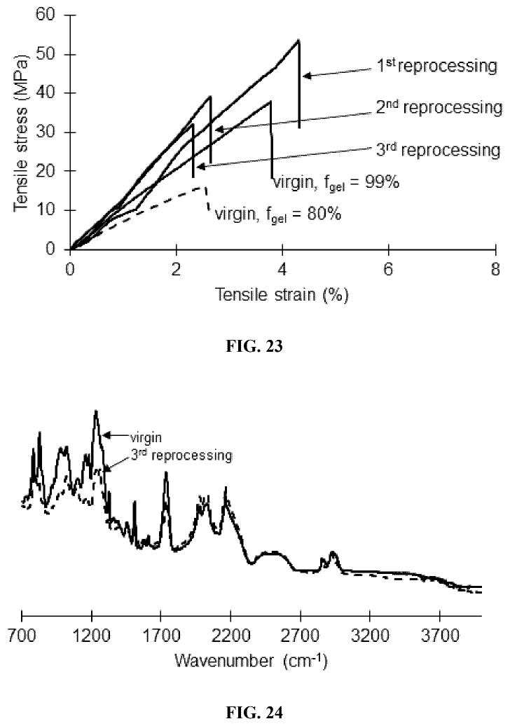

FIG. 23 is a graph showing stress-strain results for a PCHC vitrimer network material at various stages of recycle/reprocessing;

FIG. 24 is a graph showing wavenumber results for a PCHC vitrimer network material at various stages of recycle/reprocessing;

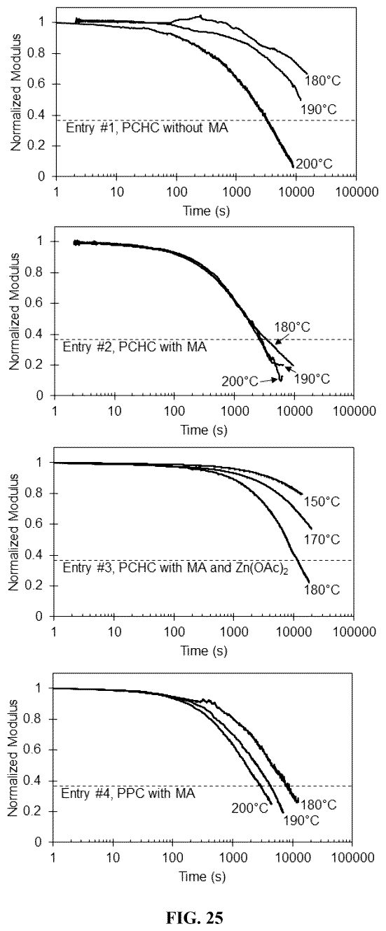

FIG. 25 is graphs showing normalized modulus results for various vitrimer network materials; and

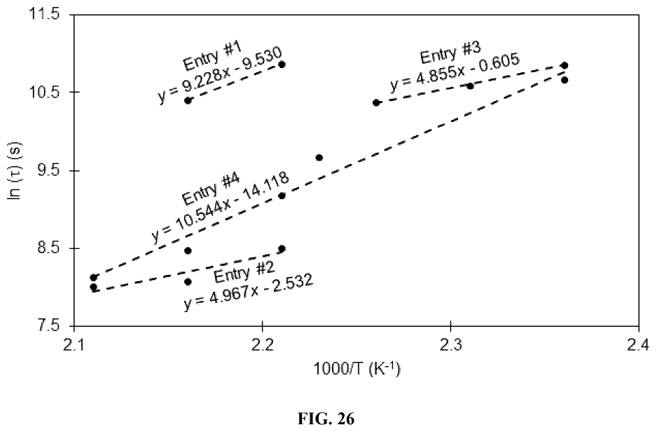

FIG. 26 is a graph showing stress relaxation results for various vitrimer network materials.

### DETAILED DESCRIPTION OF ILLUSTRATIVE EMBODIMENTS

One or more embodiments of the present invention relate to polycarbonate-based vitrimer materials, which may be referred to as β-hydroxy ester polycarbonate vitrimers. One or more embodiments of the invention relate to methods of making the polycarbonate-based vitrimer materials. The vitrimer, which may be referred to as a vitrimer network, is made by curing an epoxide group containing compound, which may be referred to as an epoxide crosslinker, with a carboxylic acid group containing compound, which may be referred to as an acid crosslinker. One or more of the epoxide group containing compound and the carboxylic acid group containing compound is a polycarbonate-based material. The polycarbonate-based material may be referred to as a capped material. That is, one or more of an epoxide capped polycarbonate and an acid capped polycarbonate will be utilized to make the β-hydroxy ester polycarbonate vitrimers. The β-hydroxy esters can be effectively introduced to the vitrimer through the reaction of the carboxylic acids and the epoxides.

The vitrimer undergoes β-hydroxyl ester-based transesterification that, in one or more embodiments, is not catalyzed by external catalysts, but rather enabled by the proximity of the hydroxyl to the ester group. In one or more embodiments, the vitrimer can therefore be produced without a Lewis acid or strong organic base as the catalyst. In other embodiments, a catalyst may be utilized, such as a zinc catalyst, which can be zinc acetate. Desired viscosity and vitrimeric transition temperature (T_{V}), the temperature above which reformability is gained, can be designed as molecular design parameters. Developing the vitrimer network material allows for tunable mechanical properties, variable glass transition, and variable stress relaxation behaviors.

The vitrimer may be referred to as a thermoset composite, and advantageously provides for chemical and thermal recyclability. Vitrimers combine mechanical advantages of thermosets with the recyclability, reprocessability, and rapid processing time of thermoplastics. Vitrimers do not include the permanent cross-links found in conventional thermosets. Instead, vitrimers include dynamic bonds, which may be referred to as dynamic crosslinks, that can be thermally triggered to undergo bond exchange to change the network topology. This covalent dynamic polymer network can be further classified as an associative network.

At service temperature, vitrimers are rigid in a manner similar to conventional thermoset polymers. At temperatures above the vitrimer transition temperature (T_{V}), vitrimers flow and behave as viscous liquid thermoplastic polymers. This switchable dual nature gives vitrimer polymers the ability to combine the high performance of thermoset polymers with the rapid processing times and recyclability of thermoplastic polymers. Such a highly recyclable, high performance thermoset polymer can be utilized in lightweight composites, primarily for the transportation sector.

The vitrimers can be utilized as the polymer matrix of carbon fiber reinforced plastics (CFRP), which are lightweight composite materials. The recyclability of the vitrimers improves the recovery of the energy intensive carbon fibers and the thermoset material and provides end-of-life value for the composites. Recycling and reforming of the vitrimers can be performed thermally, eliminating the use of potentially toxic catalyst and costly solvents. Embodiments of the present invention provide for improved recovery of the energy intensive carbon fibers and the thermoset material, thereby providing improved end-of-life value for the composites. A specific example of an end application for a carbon fiber reinforced plastic is an automotive paneling, which generally require a tensile strength of greater than 50 MPa. In other embodiments, the carbon fiber reinforced plastic containing the vitrimer can have a tensile strength of from about 50 MPa to 800 MPa, or from about 500 MPa to 800 MPa, or greater than 800 MPa. In one or more embodiments, the carbon fiber reinforced plastic containing the vitrimer can have a modulus of from about 5 GPa to 8 GPa, or from about 5 GPa to 10 GPa, or greater than 10 GPa.

The vitrimers also allow for bio-based carbon sources to be used in high-volume production for products with long service life and performance comparable to that of conventional fossil fuel-based materials. In one or more embodiments, the thermoset composite vitrimer can be produced from greater than 50 wt. % bio-based carbon sources (CO₂ and biomass). As mentioned, the thermoset composite vitrimer will also have chemical and mechanical recyclability.

Vitrimer technology offers suitable recyclability in order to overcome certain limitations of conventional epoxy resin for carbon fiber reinforced composites in automotive applications. Recycling of a vitrimer, which can be in the form of a carbon fiber reinforced plastic, can provide thermoset recoverability of greater than 60 wt. %, or greater than 80 wt. %, and carbon fiber recoverability of greater than 90 wt. %, or greater than 95 wt. %. The recoverability is through the β-hydroxy ester bond exchange reaction at the end of product service life. Additionally, when melt-recovery is not practical, a thermal depolymerization reaction to cyclic carbonate can be used to recover monomers. The recycling methods lead to aspect ratios, tenacity, and overall quality of recovered fibers that are suitably comparable to those of virgin fibers. In one or more embodiments, the recovered fibers maintain at least 90%, or at least 95%, of the mechanical properties of virgin fibers.

The vitrimers disclosed herein can be made with abundant feedstocks (epoxides, CO₂, carboxylic acids). In one or more embodiments, the feedstocks may be derived from bio-based feedstocks, such as greater than 50% bio-based, greater than 80% bio-based, or greater than 90% bio-based, or about 100% bio-based. In other embodiments, the feedstocks may be derived from fossil-fuel derived CO₂, epoxides, and carboxylic acids.

Various specific vitrimers can be designed in accord with embodiments of the present invention. The vitrimers can first be designed based on molecular design and chemical synthesis of a desired precursor. The curing chemistry can be designed to tune vitrimer transition temperature (that is, relative to reclaiming) and to manipulate properties (e.g., viscosity, tensile strength). The structure of the vitrimers can be designed to improve fiber-resin interfacial strength.

With reference to the Figures, further description of the chemistry for producing the vitrimers is now provided. As mentioned above, an epoxide group containing compound is cured with a carboxylic acid group containing compound, where one or more of the epoxide group containing compound and the carboxylic acid group containing compound is a polycarbonate-based material.

As shown in FIG. 3, a polycarbonate precursor, which may also be referred to as a CO₂-derived polycarbonate, is first prepared or obtained. In one or more embodiments, a method includes particular steps of preparing the polycarbonate precursor. In other embodiments, the polycarbonate precursor can simply be obtained from a commercial source, such as from Covestro, Aramco, BASF, and others.

Producing the CO₂-derived polycarbonate can include catalytic carboxylation of epoxides to the CO₂-derived polycarbonate. That is, the epoxide is a monomer, along with CO₂. The carbon dioxide is chemically bonded, which may also be referred to as chemically incorporated, with the epoxide. Suitable epoxides include ethylene oxide, propylene oxide, and cyclohexene oxide. The CO₂-derived polycarbonate can therefore be poly(ethylene carbonate) (PEC), poly(propylene carbonate) (PPC), or poly(cyclohexene carbonate) (PCHC).

The ethylene oxide might be chosen as the epoxide where polycarbonate precursors containing 100% bio-based content with higher wt. % CO₂ are desired. The cyclohexene oxide might be chosen as the epoxide where polycarbonate precursors having higher glass-transition temperatures (T_{g}) are desired.

The system and process for producing the vitrimers exhibits several advantages, including controlled functionality, relatively high incorporation of CO₂ (up to 50 wt. %), and thermo-catalytic back-biting/depolymerization, and is tunable with respect to mechanical properties. The process can make use of a tethered cationic cobalt catalyst, a functional chain-transfer agent (CTA) (i.e., an initiator), and the epoxide and CO₂ as monomers. In one or more embodiments, the incorporation of CO₂ in a vitrimer can be up to 50 wt. %, in other embodiments from about 5 wt. % to 50 wt. %, in other embodiments from about 10 wt. % to 50 wt. %, and in other embodiments from about 20 wt. % to 40 wt. %.

Tethered cationic catalysts can enable synthesis of perfectly alternating CO₂/epoxide copolymers with relatively high CTA:catalyst ratios. This feature makes production of low-molecular weight polymers economically feasible. Unlike double-metal cyanide (DMC) catalysts, this system produces undetectable amounts of polyether linkages. As a result, the polycarbonates (e.g., polypropylene carbonates (PPCs)) can undergo a thermocatalytic depolymerization to cyclic propylene carbonate (cPC) with high conversion and recovery. An exemplary catalyst is cobalt salen catalyst (FIG. 10). Other suitable catalysts may be generally known to the skilled person.

The functional CTA imparts architectural control over the low-molecular weight polycarbonate. The functionality of the initiator sets the functionality of the polycarbonate precursor. The initiator can be bifunctional, trifunctional, or tetrafunctional. Higher functionality will generally enable faster cure rates. The functionality of the initiator also controls the crosslinking density and mechanical properties. An exemplary bifunctional initiator is neopentyl glycol. An exemplary trifunctional initiator is 1,1,1-tris(hydroxymethyl)ethane. An exemplary tetrafunctional initiator is pyromellitic acid. Other suitable initiators may be generally known to the skilled person.

To obtain the acid crosslinker (i.e., carboxylic acid group containing compound) as the polycarbonate-based material for curing into a vitrimer, the polycarbonate precursor is reacted with a group that will provide carboxylic acid groups. Preferred groups for providing carboxylic acid groups include anhydrides such as cyclic carboxylic acid anhydrides. Exemplary cyclic anhydrides include succinic anhydride, maleic anhydride, glutaric anhydride, norbornene anhydride, diglycolic anhydride, and phthalic anhydride. This reaction can occur in the presence of a base, such as diisopropylethylamine. An exemplary base is an alkaline carbonate such as sodium carbonate. Other suitable bases may be generally known to the skilled person.

To obtain the vitrimer network when the acid crosslinker is the polycarbonate-based material, the acid crosslinker can be cured with an epoxide crosslinker which is not a polycarbonate-based material. This may be referred to as a vitrification reaction. The epoxide crosslinker can be a bisepoxide or a higher number epoxide. Exemplary epoxide crosslinkers which are not a polycarbonate-based material include diglycidyl ether of Bisphenol A (DGEBA; available under the trade name EPON 828), neopentyl glycol diglycidal ether, vinyl cyclohexene dioxide, trimethylolpropane triglycidal ether (TMPTGE), 1,4-cyclohexenedimethanol diglycidal ether (ChDGE), 4,4′methylenebis(n,n-diglycidylaniline) (MBDGA), epoxidized norbornene linseed oil (ENLO), tris(4-hydroxyphenyl)methane triglycidyl ether, poly[(phenyl glycidyl ether)-co-formaldehyde], poly[(o-cresyl glycidyl ether)-co-formaldehyde], polyethylene glycol (PEG) diglycidyl ether, and N,N-diglycidyl-4-glycidyloxyaniline.

As mentioned above, these or other embodiments include preparing vitrimeric polycarbonate precursors with end-functionalization with epoxide moieties. That is, the polycarbonate-based material can be the epoxide crosslinker (i.e., epoxide group containing compound) as the polycarbonate-based material for curing into a vitrimer. This will be achieved through a nucleophilic substitution reaction between the alcohol end-groups and, for example, epihalohydrin (e.g., epibromohydrin, epichlorohydrin) and a proton scavenger (e.g., triethylamine). Other suitable techniques and compounds may be generally known to the skilled person. An exemplary reaction for producing the polycarbonate-based material as the epoxide crosslinker is shown in FIG. 2.

To obtain the vitrimer network when the epoxide crosslinker is the polycarbonate-based material, the epoxide crosslinker can be cured with an acid crosslinker which is not a polycarbonate-based material. This also may be referred to as a vitrification reaction. The acid crosslinker which is not a polycarbonate-based material may be referred to as a carboxylic acid crosslinker. Exemplary acid crosslinkers which are not a polycarbonate-based material include malic acid (MA), citric acid, succinic acid, maleic acid, diglycolic acid, terephthalic acid, furandicarboxylic acid, acontic acid, benzenehexacarboxylic acid, 2,2′-oxydiacetic acid, trimesic acid, pyromellitic acid, tricarballylic acid, biphenyl-4,4′-dicarboxylic acid, tartaric acid, trimellitic acid, 1,2,3,4-butanetetracarboxylic acid, and other di- or polyfunctional acids generally known to the skilled person.

In one or more embodiments, both the epoxide crosslinker and the acid crosslinker can be polycarbonate-based materials. In these embodiments, the details for obtaining the epoxide crosslinker as a polycarbonate-based material and the acid crosslinker as a polycarbonate-based material are similar to the details disclosed elsewhere herein.

A general structure of an obtained vitrimer for a difunctional epoxide crosslinker is shown in FIG. 1. The circle in the middle is a residue of the initiator, which may also be referred to as the functionality of the polymeric epoxide crosslinker. The squares are a residue of the acid crosslinker, which may also be referred to as the functionality of the acid crosslinker.

Other components can be utilized with the vitrification reaction such as for cure rate, mechanical strength, and processability. An exemplary other component is an accelerator, which can be Zn(OAc)₂, Ti(OiPr)₄, or Zn(stearate).

In one or more embodiments, the vitrification reaction may be characterized by a particular temperature for the curing/reaction. In one or more embodiments, the vitrification reaction/cure may be at a temperature of from about 120° C. to 180° C., in other embodiments, from about 130° C. to 170° C., in other embodiments, from about 135° C. to 165° C., and in other embodiments, from about 140° C. to 160° C. In one or more embodiments, the vitrification reaction/cure may be at a temperature of about 140° C., in other embodiments, about 150° C., and in other embodiments, about 160° C. In one or more embodiments, the vitrification reaction/cure may be at a temperature of greater than 130° C., in other embodiments, greater than 140° C., and in other embodiments, greater than 145° C. In one or more embodiments, the vitrification reaction/cure may be at a temperature of less than 180° C., in other embodiments, less than 170° C., and in other embodiments, less than 160° C.

In one or more embodiments, the vitrimer may have a glass transition temperature (T_{g}) of from about −20° C. to 120° C., in other embodiments, from about 0° C. to 100° C., in other embodiments, from about 60° C. to 120° C., and in other embodiments, from about 80° C. to 100° C. In one or more embodiments, the vitrimer may have a glass transition temperature (T_{g}) of about 0° C., in other embodiments, about 70° C., in other embodiments, about 90° C., and in other embodiments, about 100° C. As suggested above, the T_{g} can be controlled within these ranges and at these values based on the desired properties for the vitrimer. The T_{g} may be determined with any suitable technique, which may be differential scanning calorimetry (DSC) using midpoint half height analysis values of the second heating cycle from −50° C. to 150° C.

In one or more embodiments, the vitrimer may have a vitrimer transition temperature (T_{V}), which may be referred to as topology freezing temperature, of from about 120° C. to 160° C., in other embodiments, from about 125° C. to 155° C., and in other embodiments, from about 140° C. to 150° C. In one or more embodiments, the reaction product may have a vitrimer transition temperature (T_{V}) of about 140° C., in other embodiments, about 150° C., and in other embodiments, about 160° C. In one or more embodiments, the reaction product may have a vitrimer transition temperature (T_{V}) of greater than 120° C., in other embodiments, greater than 140° C., and in other embodiments, greater than 150° C. The T_{V} may be determined with any suitable technique, which may be measured by rheometry stress relaxation or through non-isothermal creep measurements. The T_{V} may be tuned via the concentration of hydroxyl and ester groups (e.g., by molecular weights of precursors or CACs with additional hydroxyl groups).

In one or more embodiments, the polycarbonate precursor may be characterized by molecular weight. In one or more embodiments, the polycarbonate precursor may have a molecular weight of from about 500 g/mol to 3,000 g/mol, in other embodiments, from about 500 g/mol to 2,000 g/mol, in other embodiments, from about 1,000 g/mol to 3,000 g/mol, in other embodiments, from about 500 g/mol to 10,000 g/mol, in other embodiments, from about 3,000 g/mol to 5,000 g/mol, and in other embodiments, from about 3,000 g/mol to 10,000 g/mol. The molecular weight may be determined by any suitable technique, such as gel permeation chromatography (GPC).

The molecular weight of the produced vitrimer cannot be well defined and may be considered as an incalculably large number due to the crosslinked nature.

In one or more embodiments, the vitrimer may have a crosslinking density (mol/cm³) of from about 0.3 to 1.8, in other embodiments, from about 0.3 to 1.2, in other embodiments, from about 0.4 to 1, and in other embodiments, from about 1.2 to 1.7. In one or more embodiments, the vitrimer may have a crosslinking density (mol/cm³) of about 0.4, in other embodiments, about 0.5, in other embodiments, about 1.2, and in other embodiments, about 1.7.

In one or more embodiments, the vitrimer may have a molecular weight between crosslinks (g/mol) of from about 3,000 to 12,000, in other embodiments, from about 3,000 to 7,000, in other embodiments, from about 7,000 to 11,000, and in other embodiments, from about 5,000 to 12,000. In one or more embodiments, the vitrimer may have a molecular weight between crosslinks (g/mol) of about 3,000, in other embodiments, about 7,000, in other embodiments, about 11,000, and in other embodiments, about 12,000.

As mentioned above, one or more embodiments include high performance, lightweight carbon fiber/vitrimer composites with desirable tensile strength and modulus, while also maintaining recyclability. These composites may reduce the energy need, relative to conventional composites, by at least 40% based on the high recyclability of the vitrimer, which enables fiber recovery. Exemplary carbon fibers include T300 with 3 k tow. Exemplary fiber loadings include about 30 wt. %, about 50 wt. %, or about 70 wt. %. Various molding processes, such as vacuum, transfer, and compression molding, can be utilized to make the composites.

An advantage of the composites is the ability to mechanically recycle and/or chemically recycle the composites without destruction of the carbon fibers. As a result, each re-use of the carbon fibers can provide higher cost and energy savings (up to 80% per use).

Relative to recycling, in one or more embodiments, the polycarbonate moiety enables depolymerization through chain-scission with catalytic hydroxide. As shown in FIG. 5, these materials “unzip” through a back-biting mechanism to produce cyclic carbonates. In this way, up to 80 wt. % of the added polycarbonate can be recovered as the carbonate (e.g., cyclic propylene carbonate (cPC)). This may include a distillation. The carbon fibers can be removed by filtration and the carboxylic acid crosslinkers can be extracted with water for reuse. cPC is commercially produced for cosmetics, battery electrolytes, and solvents, among other uses, and can be more valuable and energy intensive than the initial monomers. Depolymerization to cPC can therefore be more economically and energetically attractive than returning to the initial monomers.

In one or more embodiments, certain end capped vitrimer networks may prevent the back-biting reaction and other recycling techniques may be utilized. For example, the vitrimer can be mixed with a depolymerization catalyst and heated to depolymerize into a carbonate (e.g., trans-cyclohexene carbonate (trans-CHC)). Suitable depolymerization catalysts include TBD, DBU, Zn acetate, MgCl₂, Co salen—TBD tethered, Cr salen+PPNCl, Cr salen+PPNN₃, NaHMDS, KHMDS, Et₃N, iPr₂Net, iPr₂NH, NaH, octylamine, n-butylamine, pyridine, neopentyl glycol, 1,1,1-THE, and t-butanol. Trans-CHC can be repolymerized, such as to provide hydroxyl terminated tri-PCHC, which can include an organocatalyst (e.g., TBD) and an initiator (e.g., 1,1,1-tris(hydroxymethyl)ethane).

In one or more embodiments, the composites can be combined with a hydroxide in order to hydrolyze a carbonate linkage and introduce chain-ends, resulting in complete depolymerization. Propylene carbonate can be recovered through distillation, the carbon fibers by filtration, and carboxylic acid crosslinkers by extraction. This recovery process can account for greater than 90 wt. % of the composite material.

In one or more embodiments, the vitrimer, which may be referred to as a crosslinked polycarbonate thermoset, can undergo a mechanical downsizing process utilizing one or more of cutting, crushing, grinding, ball-milling, or cryo-milling.

### EXAMPLES

### Example 1—Polycarbonate End-Capping (PCHC and PPC)

### Comparative Example 1A—Tri-PCHC Anhydride Capping with Amine

In a round bottom flask, hydroxyl terminated tri-PCHC(94.16 g, 174.37 mmol end-groups, 1 equiv.) was dissolved in acetone (95 mL). To this, succinic anhydride (34.89 g, 348.74 mmol, 2 equiv.) was added under stirring. Diisopropylethylamine (7.59 mL, 43.59 mmol, 0.25 equiv.) was then added using a syringe. This reaction mixture was stirred for 24 hours at 50° C. The round bottom flask was sealed using a rubber septum and an empty balloon was added to equalize excess pressure. At the end of the 24 hours, the reaction mixture was cooled to room temperature and stirred in methanol (400 mL) for 5 minutes in a 5 L two-necked flask. HCl (600 mL, 1M) was then added to precipitate the polymer onto the walls of the flask. After discarding the HCl-methanol-acetone layer, the precipitated polymer was dissolved in acetone (200 mL), dried over MgSO4 (5 g) and then dried using a roto-evaporator and Schlenk line to afford hydroxyl terminated tri-PCHC.

### Example 1B—Tri-PCHC Anhydride Capping with Amine and Carbonate Base

In a round bottom flask, hydroxyl terminated tri-PCHC (1 equiv. end-groups) was dissolved in acetonitrile so as to make a 0.25 g/mL solution of polymer in MeCN. To this, succinic anhydride (4 equiv. to end-groups) was added under stirring. Following that, sodium carbonate (4 equiv. to end-groups) was added. Diisopropylethylamine (0.25 equiv. to end-groups) was then added using a syringe. This reaction mixture was stirred for 48 hours at 50° C. The round bottom flask was sealed using a rubber septum and an air-filled balloon was added to equalize excess pressure. At the end of the 48 hours, the reaction mixture was cooled to room temperature and precipitated into acidic methanol taken in an Erlenmeyer flask and was stirred for about 10 minutes. Anhydride capped poly(cyclohexene carbonate) was precipitated on the walls of the two-necked flask. The methanol/HCl/MeCN layer was discarded and precipitated polymer was dissolved in acetone. The acetone extracts were dried over MgSO4, filtered and dried using a roto-evaporator and then under high vacuum using a Schlenk line to afford anhydride capped tri-PCHC.

### Example 1C—Tri-PCHC Epoxide Capping with Solvent

In a round bottom flask, anhydride capped tri-PCHC (from example 1A) (1 equiv. end-groups) was dissolved in acetonitrile (to make a 0.25 g/mL solution). To this, epichlorohydrin (4 equiv.) was added under stirring, followed by triethylamine (4 equiv.). This reaction mixture was stirred for 24 hours at 50° C. The round bottom flask was sealed using a rubber septum and an empty balloon was added to equalize excess pressure. At the end of the 24 hours, the reaction mixture was cooled to room temperature and stirred in methanol (400 mL) for 5 minutes in a 5 L two-necked flask. HCl (600 mL, 1M) was then added to precipitate the polymer onto the walls of the flask. After discarding the HCl-methanol-acetonitrile layer, the precipitated polymer was dissolved in acetone (200 mL), dried over MgSO₄ (5 g) and then dried using a roto-evaporator and Schlenk line to afford epoxide terminated tri-PCHC.

### Example 1D—Tri-PCHC Epoxide Capping with Neat Epichlorohydrin

In a round bottom flask, anhydride capped tri-PCHC (from example 1A) (1 equiv. end-groups) was dissolved in acetonitrile (to make a 0.25 g/mL solution). To this, epichlorohydrin (51 equiv.) and KBr (10% end-groups) was added under stirring, followed by triethylamine (4 equiv.). This reaction mixture was stirred for 24 hours at 25° C. The round bottom flask was sealed using a rubber septum and an empty balloon was added to equalize excess pressure. At the end of the 24 hours, the reaction mixture was stirred in methanol (400 mL) for 5 minutes in a 5 L two-necked flask. HCl (600 mL, 1M) was then added to precipitate the polymer onto the walls of the flask. After discarding the HCl-methanol-acetonitrile layer, the precipitated polymer was dissolved in acetone (200 mL), dried over MgSO₄ (5 g) and then dried using a roto-evaporator and Schlenk line to afford epoxide terminated tri-PCHC.

### Comparative Example 1E—Tri-PPC Anhydride Capping with Amine

In a round bottom flask, hydroxyl terminated tri-PPC (1 equiv. end-groups) was dissolved in acetone so as to make a 1.0 g/mL solution of polymer in acetone. To this, succinic anhydride (2 equiv. to end-groups) was added under stirring. Diisopropylethylamine (0.25 equiv. to end-groups) was then added using a syringe. This reaction mixture was stirred for 48 hours at 50° C. The round bottom flask was sealed using a rubber septum and an air-filled balloon was added to equalize excess pressure. At the end of the 48 hours, the reaction mixture was cooled to room temperature and precipitated into acidic methanol taken in an Erlenmeyer flask and was stirred for about 10 minutes. Anhydride capped poly(propylene carbonate) was precipitated on the walls of the two-necked flask. The HCl/MeOH/acetone layer was discarded and precipitated polymer was dissolved in acetone. The acetone extracts were dried over MgSO₄, filtered and dried using a roto-evaporator and then under high vacuum using a Schlenk line to afford anhydride capped tri-PPC.

### Example 1F—Tri-PPC Anhydride Capping with Amine and Carbonate Base

In a round bottom flask, hydroxyl terminated tri-PPC (1 equiv. end-groups) was dissolved in acetonitrile so as to make a 0.25 g/mL solution of polymer in MeCN. To this, succinic anhydride (4 equiv. to end-groups) was added under stirring. Following that, sodium carbonate (4 equiv. to end-groups) was added. Diisopropylethylamine (0.25 equiv. to end-groups) was then added using a syringe. This reaction mixture was stirred for 48 hours at 50° C. The round bottom flask was sealed using a rubber septum and an air-filled balloon was added to equalize excess pressure. At the end of the 48 hours, the reaction mixture was cooled to room temperature and precipitated into 1M HCl taken in an Erlenmeyer flask and was stirred for about 10 minutes. Anhydride capped poly(propylene carbonate) was precipitated on the walls of the two-necked flask. The HCl/MeCN layer was discarded and precipitated polymer was dissolved in acetone. The acetone extracts were dried over MgSO₄, filtered and dried using a roto-evaporator and then under high vacuum using a Schlenk line to afford anhydride capped tri-PPC.

### Example 1G—Tri-PPC Epoxide Capping with Solvent

In a round bottom flask, anhydride capped tri-PPC (from example 1e) (1 equiv. end-groups) was dissolved in acetonitrile (to make a 0.25 g/mL solution). To this, epichlorohydrin (4 equiv.) was added under stirring, followed by triethylamine (4 equiv.). This reaction mixture was stirred for 24 hours at 50° C. The round bottom flask was sealed using a rubber septum and an empty balloon was added to equalize excess pressure. At the end of the 24 hours, the reaction mixture was cooled to room temperature and stirred in methanol (400 mL) for 5 minutes in a 5 L two-necked flask. HCl (600 mL, 1M) was then added to precipitate the polymer onto the walls of the flask. After discarding the HCl-methanol-acetonitrile layer, the precipitated polymer was dissolved in acetone (200 mL), dried over MgSO₄ (5 g) and then dried using a roto-evaporator and Schlenk line to afford epoxide terminated tri-PPC.

### Example 1H—Tri-PPC Epoxide Capping with Neat Epichlorohydrin

In a round bottom flask, anhydride capped tri-PPC (from example 1a) (1 equiv. end-groups) was dissolved in acetonitrile (to make a 0.25 g/mL solution). To this, epichlorohydrin (51 equiv.) and KBr (10% end-groups) was added under stirring, followed by triethylamine (4 equiv.). This reaction mixture was stirred for 24 hours at 25° C. The round bottom flask was sealed using a rubber septum and an empty balloon was added to equalize excess pressure. At the end of the 24 hours, the reaction mixture was stirred in methanol (400 mL) for 5 minutes in a 5 L two-necked flask. HCl (600 mL, 1M) was then added to precipitate the polymer onto the walls of the flask. After discarding the HCl-methanol-acetonitrile layer, the precipitated polymer was dissolved in acetone (200 mL), dried over MgSO₄ (5 g) and then dried using a roto-evaporator and Schlenk line to afford epoxide terminated tri-PPC.

### Example 2

### Example 2A—PCHC Vitrimer Synthesis

To prepare a mixture of vitrimer precursors, ground anhydride capped triPCHC (from example 1A) (1 equiv. end-groups) was taken in a vial and to it was added difunctional, 10 trifunctional, tetrafunctional or higher functional epoxide crosslinker (equiv. to maintain stoichiometric balance with COOH end-groups). A catalyst may be added to accelerate curing and/or catalyze dynamic exchange reactions. The precursors were mixed into a paste and degassed in a vacuum oven. It was then added into a mold and cured (f_{gel}>80%). Examples 2A through 2L reflect the amounts of precursors required specifically for anhydride capped triPCHC (NMR MW=2070 g/mol).

### Example 2B—PCHC/DGEBA/Malic Acid/Zn Acetate Vitrimer Synthesis

Anhydride capped tri-PCHC (5.3 g, 7.7 mmol end-groups), malic acid (0.5 g, 7.7 mmol carboxylic acid groups), DGEBA (3.0 g, 15.3 mmol epoxy groups, average MW=386 g/mol) and zinc acetate (140 mg, 0.77 mmol, 5 mol % of tri-PCHC end groups) were mixed into a paste and degassed in a vacuum oven. It was then added into a mold and cured (f_{gel}=97%).

### Example 2C—PCHC/DGEBA/Zn Acetate Vitrimer Synthesis

Anhydride capped tri-PCHC (4.7 g, 6.9 mmol end-groups), DGEBA (1.3 g, 6.9 mmol epoxy groups, average MW=386 g/mol) and zinc acetate (76 mg, 0.34 mmol, 5 mol % of tri-PCHC end groups) were mixed into a paste and degassed in a vacuum oven. It was then added into a mold and cured (f_{gel}=91%).

### Example 2D—PCHC/DGEBA/Malic Acid Vitrimer Synthesis

Anhydride capped tri-PCHC (2.3 g, 3.4 mmol end-groups), malic acid (0.2 g, 3.4 mmol carboxylic acid groups), and DGEBA (1.3 g, 6.8 mmol epoxy groups, average MW=386 g/mol) were mixed into a paste and degassed in a vacuum oven. It was then added into a mold and cured (f_{gel}=99%).

### Example 2E—PCHC/DGEBA Vitrimer Synthesis

Anhydride capped tri-PCHC (2.9 g, 4.2 mmol end-groups), and DGEBA (0.8 g, 4.2 mmol epoxy groups, average MW=386 g/mol) were mixed into a paste and degassed in a vacuum oven. It was then added into a mold and cured (f_{gel}=95%).

### Example 2F—PCHC/DGEBA/Malic Acid/Zn Stearate Vitrimer Synthesis

Anhydride capped tri-PCHC (12.8 g, 18.5 mmol end-groups), malic acid (1.2 g, 18.5 mmol carboxylic acid groups), DGEBA (7.2 g, 37.0 mmol epoxy groups, average MW=386 g/mol) and zinc stearate (703 mg, 1.11 mmol, 3 mol % of tri-PCHC end groups) were mixed into a paste and degassed in a vacuum oven. It was then added into a mold and cured (f_{gel}=91 0%).

### Example 2G—PCHC/DGEBA/Zn Stearate Vitrimer Synthesis

Anhydride capped Tri-PCHC (lg, 1.4 mmol end-groups) was mixed with DGEBA (0.27 g, 1.4 mmol epoxy groups, average MW=386 g/mol) and zinc stearate (44 mg, 0.07 mmol, 5 mol % of tri-PCHC end groups). The above precursors were mixed into a paste and degassed in a vacuum oven. It was then added into a mold and cured (f_{gel}>80%).

### Example 2H—PCHC/TMPTGE/Zn Stearate Vitrimer Synthesis

Anhydride capped Tri-PCHC (lg, 1.4 mmol end-groups) was mixed with TMPTGE (0.13 mL, 1.4 mmol epoxy groups) and zinc stearate (44 mg, 0.07 mmol, 5 mol % of tri-PCHC end groups). The above precursors were mixed into a paste and degassed in a vacuum oven. It was then added into a mold and cured (f_{gel}=99%).

### Example 21—PCHC/ChDGE/Zn Stearate Vitrimer Synthesis

Anhydride capped Tri-PCHC (lg, 1.4 mmol end-groups) was mixed with ChDGE (0.17 mL, 1.4 mmol epoxy groups) and zinc stearate (44 mg, 0.07 mmol, 5 mol % of tri-PCHC end groups). The above precursors were mixed into a paste and degassed in a vacuum oven. It was then added into a mold and cured (f_{gel}=94%).

### Example 2J—PCHC/MBDGA/Zn Stearate Vitrimer Synthesis

Anhydride capped Tri-PCHC (lg, 1.4 mmol end-groups) was mixed with MBDGA (0.15 g, 1.4 mmol epoxy groups) and zinc stearate (44 mg, 0.07 mmol, 5 mol % of tri-PCHC end groups). The above precursors were mixed into a paste and degassed in a vacuum oven. It was then added into a mold and cured (f_{gel}=83%).

### Example 2K—PCHC/NGDGE/Zn Stearate Vitrimer Synthesis

Anhydride capped Tri-PCHC (lg, 1.4 mmol end-groups) was mixed with NGDGE (0.15 g, 1.4 mmol epoxy groups) and zinc stearate (44 mg, 0.07 mmol, 5 mol % of tri-PCHC end groups). The above precursors were mixed into a paste and degassed in a vacuum oven. It was then added into a mold and cured (f_{gel}>80%).

### Example 2L—PCHC/Biobased Epoxidized Natural Oil/Zn Stearate Vitrimer Synthesis

Anhydride capped Tri-PCHC (lg, 1.4 mmol end-groups) was mixed with biobased epoxidized natural oil such as epoxidized norbornene linseed oil (0.39 g, 1.4 mmol epoxy groups, epoxy equivalent weight=275 g/eq.) and zinc stearate (44 mg, 0.07 mmol, 5 mol % of tri-PCHC end groups). The above precursors were mixed into a paste and degassed in a vacuum oven. It was then added into a mold and cured (f_{gel}=82%).

### Example 3

### Example 3A—PPC Vitrimer Synthesis

To prepare a mixture of vitrimer precursors, ground anhydride capped triPPC (from example 1E) (1 equiv. end-groups) was taken in a vial and to it was added difunctional, trifunctional, tetrafunctional or higher functional epoxide crosslinker (equiv. to maintain stoichiometric balance with COOH end-groups). A catalyst may be added to accelerate curing and/or catalyze dynamic exchange reactions. The above precursors were mixed into a paste and degassed in a vacuum oven. It was then added into mold of choice and cured (f_{gel}>80%). Examples 3A through 3L reflect the amounts of precursors required specifically for anhydride capped triPPC (NMR MW=2070 g/mol).

### Example 3B—PPC/DGEBA/Malic Acid Vitrimer Synthesis

Anhydride capped tri-PPC (2.3 g, 3.4 mmol end-groups), malic acid (0.2 g, 3.4 mmol carboxylic acid groups), and DGEBA (1.3 g, 6.8 mmol epoxy groups, average MW=386 g/mol) were mixed into a paste and degassed in a vacuum oven. It was then added into a mold and cured (f_{gel}=100%).

### Example 3C—PPC/DGEBA/Zn Stearate Vitrimer Synthesis

Anhydride capped Tri-PPC (lg, 1.4 mmol end-groups) was mixed with DGEBA (0.27 g, 1.4 mmol epoxy groups, average MW=386 g/mol) and zinc stearate (44 mg, 0.07 mmol, 5 mol % of tri-PPC end groups). The above precursors were mixed into a paste and degassed in a vacuum oven. It was then added into a mold and cured (f_{gel}=95%).

### Example 3D—PPC/TMPTGE/Zn Stearate Vitrimer Synthesis

Anhydride capped Tri-PPC (1 g, 1.4 mmol end-groups) was mixed with TMPTGE (0.13 mL, 1.4 mmol epoxy groups) and zinc stearate (44 mg, 0.07 mmol, 5 mol % of tri-PPC end groups). The above precursors were mixed into a paste and degassed in a vacuum oven. It was then added into a mold and cured (f_{gel}=98%).

### Example 3E—PPC/ChDGE/Zn Stearate Vitrimer Synthesis

Anhydride capped Tri-PPC (1 g, 1.4 mmol end-groups) was mixed with ChDGE (0.17 mL, 1.4 mmol epoxy groups) and zinc stearate (44 mg, 0.07 mmol, 5 mol % of tri-PPC end groups). The above precursors were mixed into a paste and degassed in a vacuum oven. It was then added into a mold and cured (f_{gel}=97%).

### Example 3F—PPC/MBDGA/Zn Stearate Vitrimer Synthesis

Anhydride capped Tri-PPC (1 g, 1.4 mmol end-groups) was mixed with MBDGA (0.15 g, 1.4 mmol epoxy groups) and zinc stearate (44 mg, 0.07 mmol, 5 mol % of tri-PPC end groups). The above precursors were mixed into a paste and degassed in a vacuum oven. It was then added into a mold and cured (f_{gel}=99%).

### Example 3G—PPC/NGDGE/Zn Stearate Vitrimer Synthesis

Anhydride capped Tri-PPC (1 g, 1.4 mmol end-groups) was mixed with NGDGE (0.15 g, 1.4 mmol epoxy groups) and zinc stearate (44 mg, 0.07 mmol, 5 mol % of tri-PPC end groups). The above precursors were mixed into a paste and degassed in a vacuum oven. It was then added into a mold and cured (f_{gel}>80%).

### Example 3H—PPC/Biobased Epoxidized Natural Oil/Zn Stearate Vitrimer Synthesis

Anhydride capped Tri-PPC (1 g, 1.4 mmol end-groups) was mixed with biobased epoxidized natural oil such as epoxidized norbornene linseed oil (0.39 g, 1.4 mmol epoxy groups, epoxy equivalent weight=275 g/eq.) and zinc stearate (44 mg, 0.07 mmol, 5 mol % of tri-PPC end groups). The above precursors were mixed into a paste and degassed in a vacuum oven. It was then added into a mold and cured (f_{gel}=96%).

### Example 4—Combinations of Polycarbonates

Toughening of high strength PCHC networks can be achieved by combining PCHC and PPC precursors with suitable crosslinkers. In one example, acid capped tri-PPC (1 g, 1.4 mmol end-groups) and acid capped tri-PCHC (1 g, 1.4 mmol end-groups) were mixed with DGEBA (0.54 g, 2.84 mmol epoxy groups, average MW=386 g/mol) and zinc stearate (88 mg, 0.14 mmol, 5 mol % of acid end groups). The above precursors were mixed into a paste and degassed in a vacuum oven. It was then added into a mold and cured (f_{gel}>80%).

### Example 5—High-CO₂ Content Vitrimers

All polycarbonate vitrimers can be synthesized using combinations of acid capped PPC or PCHC with the epoxide capped PPC or PCHC. In one example, acid capped tri-PPC (lg, 1.4 mmol end-groups) was mixed with epoxide capped PPC (1.5 g, 1.4 mmol epoxide end-groups) and zinc stearate (44 mg, 0.07 mmol, 5 mol %) was added. The precursors were mixed into a homogeneous mixture and degassed in a vacuum oven. The mixture was poured into a mold and cured (f_{gel}>80%).

### Example 6—Mechanical Recycling

### Example 6A—Mechanical Recycling of Polycarbonate Thermoset

A crosslinked polycarbonate thermoset, as described in Example 2A through 2L or Example 3A through 3H can undergo a downsizing process through cutting, crushing, grinding, ball-milling, or cryo-milling. The resulting downsized material can be introduced into a selected mold and heated for reprocessing. This procedure can be iteratively repeated to yield materials with multiple cycles of recycling.

### Example 6B—PCHC/Malic Acid/DGEBA/Zinc Acetate Vitrimer Reprocessing

Crosslinked PCHC thermoset from example 2B (5 g) was added into ball-milling jar with balls (6 balls, 12 mm diameter). The jar was cooled and shaken to give ground thermoset. The resulting ground thermoset was then added into a selected mold and heated for reprocessing. The above procedure was iteratively repeated up to 3 cycles to yield recycled materials.

### Example 6C—PCHC/Malic Acid/DGEBA/Zinc Stearate Vitrimer Reprocessing

Crosslinked PCHC thermoset from example 2B (5 g) was added into ball-milling jar with balls (6 balls, 12 mm diameter). The jar was cooled and shaken to give ground thermoset. The resulting ground thermoset was then added into a selected mold and heated for reprocessing. The above procedure was iteratively repeated up to 3 cycles to yield recycled materials.

### Example 7—Chemical Recycling

### Example 7A—PCHC Vitrimer Depolymerization

Crosslinked end-capped tri-PCHC vitrimer network as from Example 2A through 2L (1 g) was stirred with a depolymerization catalyst and heated to depolymerize into trans-cyclohexene carbonate (trans-CHC).

### Example 7B—PCHC Vitrimer Depolymerization Using Zinc Acetate

Crosslinked end-capped tri-PCHC vitrimer network as from Example 2B (1 g, contains 44% by weight tri-PCHC) was stirred with zinc acetate dihydrate (5 wt % of vitrimer) and heated under vacuum to depolymerize into trans-cyclohexene carbonate (trans-CHC) with >70% yield (of theoretical maximum).

### Example 7C—PCHC Vitrimer Depolymerization Using TBD Tethered Cobalt Salen

Crosslinked end-capped tri-PCHC vitrimer network as from Example 2B (1 g, contains 44% by weight tri-PCHC) was stirred with TBD tethered cobalt salen catalyst (1 wt % of vitrimer) and heated under vacuum to depolymerize into trans-cyclohexene carbonate (trans-CHC) with >72% yield (of theoretical maximum).

### Example 7D—PCHC Vitrimer Depolymerization Using Chromium Salen and PPNCl

Crosslinked end-capped tri-PCHC vitrimer network as from Example 2F (1 g, contains 45% by weight tri-PCHC) was stirred with chromium salen and PPNCl (1 wt % of vitrimer) and heated under vacuum to depolymerize into trans-cyclohexene carbonate (trans-CHC) with >73% yield (of theoretical maximum).

### Example 7E—Trans-CHC Repolymerization to Tri-PCHC

Trans-CHC that was synthesized by depolymerizing crosslinked end-capped tri-PCHC as in examples 7A through 7D, was repolymerized to afford hydroxyl terminated tri-PCHC using TBD as organocatalyst and 1,1,1-tris(hydroxymethyl)ethane as initiator using the monomer:initiator:catalyst ratios as shown in Table 1.

TABLE 1

| | | | M_{n, theo} = | | | | |
|---|---|---|---|---|---|---|---|
| Run | | Reaction | Yield/[I] | MW_{NMR} | T_{g} | GPC | |
| # | [M]:[I]:[catalyst] | conditions | (g/mol) | (g/mol) | (° C.) | Mₙ | Ð |
| SJ-4-173 | 265:20:1 | 60° C., 4 h | 720 | 1040 | 39 | N.D. | N.D. |
| SJ-4-174 | 13:1:1 | 60° C., 24 h | 806 | 1700 | 65 | 240 | 3.4 |
| SJ-4-175 | 66:5:1 | 60° C., 4 h | 770 | 1560 | 59 | 500 | 2.0 |
| SJ-4-176 | 66:5:1 | 60° C., 24 h | 920 | 1710 | 58 | 360 | 2.7 |
| SJ-4-182-1 | 13:1:4 | 60° C., 24 h | 1720 | 2200 | 60 | 760 | 1.5 |
| SJ-4-182-1 | 13:1:2 | 60° C., 24 h | 1990 | 2230 | 58 | 870 | 1.4 |

### Example 7F—PPC Vitrimer Depolymerization

Crosslinked end-capped tri-PPC vitrimer network as from Examples 3A through 3H (1 g) can be stirred with a depolymerization catalyst and heated to depolymerize into cyclic propylene carbonate (cPC).

### Example 8—PCHC with Various Epoxides

PCHC vitrimer network materials were prepared with zinc stearate and a variety of epoxides. Gel fraction (%) results are shown in FIG. 12.

### Example 9—PPC with Various Epoxides

PPC vitrimer network materials were prepared with zinc stearate and a variety of epoxides. Gel fraction (%) results are shown in FIG. 13.

### Example 10—Curing Kinetics

FIG. 14 shows curing kinetic results for PCHC vitrimer network materials prepared with various catalysts/materials. FIG. 15 shows curing kinetic results for PCHC vitrimer network materials prepared with and without zinc acetate. FIG. 16 shows curing kinetic results for PCHC vitrimer network materials prepared with zinc acetate and at various temperatures.

### Example 11—Material Properties

Vitrimer network materials were made according to the general details shown in Table 2 below. FIG. 17 shows heat flow results (delayed to the melting and softening points of the materials) for the vitrimer network materials. FIG. 18 shows thermogravimetric analysis results for the vitrimer network materials. FIG. 19 shows stress-strain results for the vitrimer network materials.

TABLE 2

| Entry | Precursor | DGEBA | MA | Zn(OAc)₂ | f_{gel} | T_{g} | T_{d} | σ_{at break} | E |
|---|---|---|---|---|---|---|---|---|---|
| # | (1 equiv.) | (equiv) | (equiv.) | (equiv.) | (%) | (° C.) | (° C.) | (MPa) | (GPa) |
| 1 | PCHC | — | — | — | — | 61 | 270 | — | — |
| 2 | PCHC | 1.5 | — | — | 95 | 91 | 289 | 36 | 2 |
| 3 | PCHC | 3 | 1.5 | — | 94 | 90 | 289 | 39 | 1.5 |
| 4 | PCHC | 3 | 1.5 | 0.3 | 98 | 87 | 275 | 38 | 1 |
| 5 | PPC | — | — | — | — | 12 | 242 | — | — |
| 6 | PPC | 3 | 1.5 | — | 93 | 46 | 262 | 61 | 0.9 |

### Example 12—Recycling

A PCHC vitrimer network material was prepared utilizing malic acid (MA) and zinc acetate. The vitrimer material was recycled/reprocessed according to the general schematic shown in FIG. 20. The reprocessing was done at a temperature of 160° C. for 4 hours. The reprocessing was done three times. FIG. 21 shows storage modulus results for the PCHC vitrimer network material at the various stages of the reprocessing. FIG. 22 shows tan delta results for the PCHC vitrimer network material at the various stages of the reprocessing. FIG. 23 shows stress-strain results for the PCHC vitrimer network material at the various stages of the reprocessing. FIG. 24 shows wavenumber results for the initial PCHC vitrimer network material and the PCHC vitrimer network material after three reprocessing steps. Other property results are shown in Table 3 below.

TABLE 3

| | E′_{rubbery plateau} | u^{e} | Mₓ |
|---|---|---|---|
| Sample | (MPa) | (mol/cm³) | (g/mol) |
| Virgin | 0.38 | 0.37 × 10⁻⁴ | 11170 |
| 1st reprocessing | 1.76 | 1.71 × 10⁻⁴ | 2380 |
| 2nd reprocessing | 1.22 | 1.18 × 10⁻⁴ | 3330 |
| 3rd reprocessing | 0.54 | 0.52 × 10⁻⁴ | 7440 |

### Example 13—Material Properties

Vitrimer network materials were made according to the general details shown in Table 4 below. FIG. 25 shows normalized modulus results for the various vitrimer network materials. FIG. 26 shows stress relaxation results for the various vitrimer network materials.

TABLE 4

| Entry | Precursor | DGEBA | MA | Zn(OAc)₂ | Eₐ |
|---|---|---|---|---|---|
| # | (1 equiv.) | (equiv.) | (equiv.) | (equiv. | (kJ/mol) |
| 1 | PCHC | 1.5 | — | — | 77 |
| 2 | PCHC | 3 | 1.5 | — | 41 |
| 3 | PCHC | 3 | 1.5 | 0.3 | 40 |
| 4 | PPC | 3 | 1.5 | — | 87 |

In light of the foregoing, it should be appreciated that the present invention significantly advances the art by providing improved vitrimer materials and corresponding methods. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A method of producing a vitrimer, the method comprising steps of
providing an epoxide group containing compound;
providing a carboxylic acid group containing compound; wherein one or more of the epoxide group containing compound and the carboxylic acid group containing compound is a polycarbonate-based material;
combining the epoxide group containing compound with the carboxylic acid group containing compound to form a reaction mixture; and
subjecting the reaction mixture to conditions that will allow the epoxide group containing compound to react with the carboxylic acid group containing compound to thereby form the vitrimer; wherein the vitrimer includes a β-hydroxy ester group where the epoxide group reacts with the carboxylic acid group.

2. The method of claim 1, wherein only the epoxide group containing compound is a polycarbonate-based material.

3. The method of claim 1, wherein only the carboxylic acid group containing compound is a polycarbonate-based material.

4. The method of claim 1, wherein both the epoxide group containing compound and the carboxylic acid group containing compound are polycarbonate-based materials.

5. The method of claim 1, wherein the epoxide group containing compound and the carboxylic acid group containing compound are made of feedstocks which are greater than 80% bio-based.

6. The method of claim 1, wherein from about 5 wt. % to 50 wt. % of the vitrimer is derived from CO₂.

7. The method of claim 1, wherein the epoxide group containing compound is a polycarbonate-based material and is one or more of poly(ethylene carbonate) (PEC), poly(propylene carbonate) (PPC), and poly(cyclohexene carbonate) (PCHC).

8. The method of claim 1, wherein the carboxylic acid group containing compound is a polycarbonate-based material, where the carboxylic acid group containing compound is made by reacting a polycarbonate precursor with a cyclic anhydride.

9. The method of claim 8, wherein the cyclic anhydride includes one or more of succinic anhydride, maleic anhydride, glutaric anhydride, norbornene anhydride, diglycolic anhydride, and phthalic anhydride.

10. The method of claim 1, wherein the epoxide group containing compound is not a polycarbonate-based material and includes one or more of diglycidyl ether of Bisphenol A (DGEBA), neopentyl glycol diglycidal ether, vinyl cyclohexene dioxide, trimethylolpropane triglycidal ether (TMPTGE), 1,4-cyclohexenedimethanol diglycidal ether (ChDGE), 4,4′methylenebis(n,n-diglycidylaniline) (MBDGA), epoxidized norbornene linseed oil, tris(4-hydroxyphenyl)methane triglycidyl ether, poly[(phenyl glycidyl ether)-co-formaldehyde], poly[(o-cresyl glycidyl ether)-co-formaldehyde], polyethylene glycol (PEG) diglycidyl ether, and N,N-diglycidyl-4-glycidyloxyaniline.

11. The method of claim 1, wherein the carboxylic acid group containing compound is not a polycarbonate-based material and includes one or more of malic acid, citric acid, succinic acid, maleic acid, diglycolic acid, terephthalic acid, furandicarboxylic acid, acontic acid, benzenehexacarboxylic acid, 2,2′-oxydiacetic acid, trimesic acid, pyromellitic acid, tricarballylic acid, biphenyl-4,4′-dicarboxylic acid, tartaric acid, trimellitic acid, and 1,2,3,4-butanetetracarboxylic acid.

12. The method of claim 1, wherein the vitrimer has a glass transition temperature (T_{g}) of from about −20° C. to 120° C.

13. The method of claim 1, wherein the vitrimer has a vitrimer transition temperature (T_{V}) of from about 120° C. to 160° C.

14. The method of claim 1, wherein the conditions that will allow the epoxide group containing compound to react with the carboxylic acid group containing compound include a temperature of from about 135° C. to 165° C.

15. The method of claim 1, wherein the conditions that will allow the epoxide group containing compound to react with the carboxylic acid group containing compound include a temperature of about 150° C.

16. The method of claim 1, further comprising a step of chemically recycling the vitrimer.

17. The method of claim 1, further comprising a step of mechanically recycling the vitrimer.

18. A composition comprising a vitrimer which is a reaction product of an epoxide group containing compound and a carboxylic acid group containing compound; wherein one or more of the epoxide group containing compound and the carboxylic acid group containing compound is a polycarbonate-based material.

19. The composition of claim 18, wherein the vitrimer is defined by the following structure [chemical structure]
